(19) United States
(12) Patent Application Publication
(10) Pub. No.: US 2012/0042442 A1
(43) Pub. Date: Feb. 23, 2012

(54) FIREPROOF FABRIC AND FIREPROOF CLOTHING INCLUDING SAME

(75) Inventors: Masanobu Takahashi, Osaka (JP); Keita Tasaki, Osaka (JP); Takashi Tamura, Aichi (JP)

(73) Assignees: SABIC INNOVATIVE PLASTICS IP B.V., Bergen op Zoom (NL); THE JAPAN WOOL TEXTILE CO., LTD., Kobe-shi, Hyogo (JP)

(21) Appl. No.: 13/260,079

(22) PCT Filed: Feb. 23, 2010
(86) PCT No.: PCT/JP10/52712

§ 371 Date: Sep. 23, 2011

(30) Foreign Application Priority Data
Apr. 24, 2009 (JP) 2009-106722

(51) Int. Cl. A62B 17/00; D04B 21/00; D04H 13/00; D03D 15/12

(52) U.S. Cl. 2/458; 442/302; 442/304; 442/414; 442/189; 442/308; 442/334; 442/187; 442/307; 442/333

(57) ABSTRACT

A fabric for fireproof clothing of the present invention is a fireproof fabric including flame-retardant fibers. The fabric is a woven fabric, a knitted fabric or a nonwoven fabric including 70 to 100 mass % of a polyetherimide fiber and 0 to 30 mass % of another flame-retardant fiber. The flame resistance, the heat resistance, and the wash resistance under ISO 11613-1999 as the international performance standards for fireproof clothing are: (1) flame resistance to be free from hole formation, dripping and melting; and to have afterflame time and afterglow time of not more than 2 seconds; (2) heat resistance to be free from firing, separation, dripping and melting; and to have a shrinkage rate of not more than 5%; and (3) washing resistance to have a shrinkage rate of not more than 3%. The fireproof clothing of the present invention includes the fireproof fabric fabricated as an inner liner. Thereby, the present invention provides a fabric for fireproof clothing that has excellent light resistance and heat resistance, and preferable dye-affinity and that can be produced at low cost, and fireproof clothing using the fabric.

### TECHNICAL FIELD

The present invention relates to a fireproof fabric and fireproof clothing using the same.

### BACKGROUND ART

Fireproof fabrics have been applied widely for example, to fire-fighting clothing; curtains, carpets, chair-covering sheets and panel materials used in hospitals, theaters, airplanes, vehicles and the like. For example, a para-aramid fiber is used in general for fireproof clothing such as fire-fighting clothing that is required to have strength and heat resistance. However, the para-aramid fiber is problematic in that it has poor light resistance and undergoes photodegradation when exposed to sunlight, exhibiting an immediate loss of strength and suffering discoloration. Therefore, blending with a meta-aramid fiber or the like has been proposed for securing light resistance (Patent Documents 1 and 2).

However, even if a para-aramid fiber and a meta-aramid fiber are blended as proposed in Patent Document 1, the problems still remain, namely, the para-aramid fiber present on the surface undergoes photodegradation when exposed to sunlight, immediately loses strength, and experiences discoloration. In the case of a blended yarn in particular, since respective fibers that constitute the spun yarn are moved outward and inward within the yarn due to a phenomenon called migration, degradation that has occurred in exposed portions results in deterioration in the strength of the entire yarn. Moreover, an ordinary multilayer-structured spun yarn is also problematic in that the core fiber and the cover fiber separate and a high-tenacity yarn is not likely to be obtained. There is also a problem that both the para-aramid fiber and the meta-aramid fiber are difficult to dye, and due to the necessity of using a spun-dyed yarn, the degree of freedom in color pattern is restricted.

### PRIOR ART DOCUMENTS

### Patent Documents

Patent document 1: JP 2007-077537 A
Patent document 2: JP 2008-101294 A

### DISCLOSURE OF INVENTION

### Problem to be Solved by the Invention

In order to address the aforementioned problems of the conventional art, the present application provides a fireproof fabric having excellent light resistance and heat resistance, and preferable dye-affinity, and that can be produced at a low cost. The present application also provides fireproof clothing using the fireproof fabric.

### Means for Solving Problem

A fireproof fabric of the present application includes flame-retardant fibers. The fabric is a woven fabric, a knitted fabric or a nonwoven fabric comprising 70 to 100 mass % of a polyetherimide fiber and 0 to 30 mass % of another flame-retardant fiber. The fabric has flame resistance, heat resistance and wash resistance under ISO 11613-1999 as the international performance standards for fireproof clothing:
(1) flame resistance to be free from hole formation, dripping and melting; and to have afterflame time and afterglow time of not more than 2 seconds;
(2) heat resistance to be free from firing, separation, dripping and melting; and to have a shrinkage rate of not more than 5%; and
(3) washing resistance to have a shrinkage rate of not more than 3%.

Fireproof clothing of the present invention is characterized in that it includes the fireproof fabric fabricated as an inner liner.

### Effects of the Invention

The present invention can provide a fireproof fabric that has excellent light resistance and heat resistance and preferable dye-affinity and also can be produced at a low cost, and fireproof clothing using the same, since the fireproof fabric is a woven fabric, a knitted fabric or a nonwoven fabric including 70-100 mass % of a polyetherimide fiber and 0 to 30 mass % of another flame-retardant fiber. Namely, the above-mentioned effect is obtainable since the fabric is based on the polyetherimide fiber having excellent light resistance and heat resistance. Moreover, since the polyetherimide fiber has preferable dye-affinity, the fabric based on the fiber also has preferable dye-affinity.

### BRIEF DESCRIPTION OF DRAWINGS

FIGS. 1A-1E are explanatory views showing a honeycomb weave as an example of the present application. FIG. 1A shows warping, FIG. 1B shows an order of heddles from the cloth fell, FIG. 1C shows draw-in of a reed, FIG. 1D shows the texture of the woven fabric, and FIG. 1E shows corresponding floating and sinking of yarns for every heddle.

### DESCRIPTION OF THE INVENTION

The fireproof fabric of the present invention is made of 70 to 100 mass % of a polyetherimide fiber and 0 to 30 mass % of another flame-retardant fiber. It is preferable that the polyetherimide single fiber has a fineness of not more than 3.9 decitex (3.5 deniers) and more preferably not more than 3.3 decitex (3.0 deniers). When the fineness is not more than 3.9 decitex (3.5 deniers), the fiber has flexibility and preferable feeling, and it can be applied suitably to an inner liner for fireproof clothing. A preferable average fiber length of the polyetherimide fiber is in a range of 30 to 220 mm, and more preferably, in a range of 60 to 150 mm, and particularly preferably in a range of 90 to 110 mm. The polyetherimide fiber having the fiber length in the above range can be spun easily. In a case of using the polyetherimide fiber and the other flame-retardant fiber, a fiber sheet is formed from a uniformly blended product. For the fiber sheet, a woven fabric, a knitted fabric or a nonwoven fabric is preferred. Further, the polyetherimide fiber can be dyed with a disperse dye, and thus it can be dyed to have various colors just like polyester. Dyeing can be carried out as yarn-dyeing (dyeing of fibers or yarns) or piece-dyeing (dyeing of cloths).

70 to 100 mass % of the polyetherimide fiber and 0 to 30 mass % of the other flame-retardant fiber are blended and spun. More preferably, the rate of the polyetherimide fiber is 75 to 95 mass % and the rate of the other flame-retardant fiber is 5 to 25 mass %. The other flame-retardant fiber is preferably at least one fiber selected from the group consisting of wool, frame-retardant rayon, frame-retardant acrylic, aramid, flame-retardant cotton and flame-retardant vinylon.

Hereinafter, the respective fibers will be described.

### 1. Polyetherimide Fiber

An example of the polyetherimide fiber is “Ultem” manufactured by Sabic Innovative Plastics (limiting oxygen index (LOI): 32). This fiber has a tensile strength of about 3 cN/decitex.

### 2. Other Flame-Retardant Fiber

(1) Wool: commonly-used merino wool or the like can be used. The wool can be used in a natural state or it can be dyed. Alternatively, wool that has been modified by for example removing the surface scales for shrink proofing can be used. The natural or dyed wool is called “unmodified wool”. The scale removal itself is a commonly known process for shrink proofing, and it is performed by chlorination. Such an unmodified or modified wool is used to improve hygroscopicity and to shield a radiant heat so that the comfort in wearing is kept preferable despite wetting from sweat during exertion under a high-temperature and severe environment, thereby exhibiting heat resistance for protecting human body. The above-mentioned effect can be obtained also by using wool that has been subjected to a ZIRPRO process (a process with titanium and zirconium salt). This process developed by the International Wool Standard Secretariat is well known as a process for providing flame-retardance to wool.
(2) Flame-retardant rayon: examples of flame-retardant rayon include a rayon that has been subjected to a PROBAN process (an ammonium curing process using tetrakis hydroxymethyl phosphonium salt) developed by Albright & Wilson Ltd.), a rayon that has been subjected to a Pyrovatex CP process (process with N-methylol dimethylphosphonopropionamide) developed by Ciba-Geigy, and “Viscose FR (trade name) manufactured by Lenzing AG in Austria.
(3) Flame-retardant acrylic: examples of the flame-retardant acrylic fiber include a modacrylic fiber “Protex M” manufactured by Kaneka Corporation (limiting oxygen index (LOI): 32), trade name “Rufnen” manufactured by the former Kanebo Corporation/Marutake Co. Ltd., and the like. These fibers have a tensile strength of about 2 to 3 cN/decitex.
(4) Flame-retardant cotton: examples of flame-retardant cotton include a cotton that has been subjected to a PROBAN process (an ammonium curing process using tetrakis hydroxymethyl phosphonium salt) developed by Albright & Wilson Ltd.), and a cotton that has been subjected to a Pyrovatex CP process (process with N-methylol dimethylphosphonopropionamide) developed by Ciba-Geigy.
(5) Flame-retardant vinylon: examples of the flame-retardant vinylon include “Bainal” (trade name) manufactured by Kuraray Co., Ltd.
(6) Aramid: for an aramid fiber, any of a para-aramid fiber and a meta-aramid fiber can be used in the present application. The para-aramid fiber has high tensile strength (for example, “Technora” manufactured by Teijin, Ltd., 24.7 cN/decitex; “Kevlar” manufactured by DuPont, 20.3 to 24.7 cN/decitex). In addition, the thermal decomposition starting temperature is high (about 500° C. for both of the above products) and the limiting oxygen index (LOI) is in a range of 25-29, and thus the products can be used preferably for a heat-resistant fabric and heat-resistant protective suits. It is preferable that the single-fiber fineness of the para-aramid fiber is in a range of 1 to 6 decitex, and more preferably, in a range of 2 to 5 decitex. Examples of the meta-aramid fiber include “Conex” manufactured by Teijin, Ltd. (limiting oxygen index (LOI): 30) and “Nomex” manufactured by DuPont (limiting oxygen index (LOI): 30), and they have a tensile strength of about 4 to 7 cN/decitex.

For making a blended yarn, according to a usual spinning method, the fibers are blended in steps such as carding, roving, drafting or any other preceding steps so as to manufacture a spun yarn. The spun yarn can be used as a single yarn or a plurality of yarns can be twisted together. These yarns are used as warps and wefts to provide a woven fabric. Examples of the woven fabric include a honeycomb weave, a plain weave, twill weave, and satin weave. In particular, as the honeycomb weave having a relief structure provides high thermal insulation effect due to the included air, it is used preferably as an inner liner for fireproof clothing. For the intermediate waterproof cloth of the fireproof clothing, the plain weave, the twill weave or the satin weave, which tend not to hold water, are used preferably. In a case of knitted fabric, any of flat knitting, circular knitting, and warp knitting can be applied. There is no particular limitation on the knitted texture. When air is to be included in the knitted fabric, a double linkage pile fabric is formed. For forming a nonwoven fabric, for example, a card web is formed, which may be subjected to a process such as needle-punching, water jet, stitch bonding and embossing as required.

Any usual sewing can be used for sewing the fireproof fabric of the present invention in order to make an inner liner of fireproof clothing. In this context, the inner liner denotes a cloth to be arranged on the side of a torso-covering fabric closest to the body.

It is preferable that the weight per unit of the fabric (metsuke) is in a range of 100 to 300 g/m², so that lighter and more comfortable working clothing can be provided. It is more preferable that the range is 130 to 270 g/m², and particularly preferably 180 to 250 g/m².

The fabric has the below-mentioned properties, i.e., flame resistance, heat resistance and wash resistance under ISO 11613-1999 as the international performance standards for fireproof clothing: (1) flame resistance to be free from hole formation, dripping and melting; and to have afterflame time and afterglow time of not more than 2 seconds; (2) heat resistance to be free from firing, separation, dripping and melting; and to have a shrinkage rate of not more than 5%; and (3) washing resistance to have a shrinkage rate of not more than 3%. Thereby, the inner liner of fireproof clothing shields a radiant heat so that the comfort in wearing is kept preferable despite wetting from sweat during exertion under a high-temperature and severe environment, thereby exhibiting heat resistance for protecting human body.

It is preferable that an antistatic fiber further is added to the fabric. This is to inhibit the charging of the fabric when the final product is in use. Examples of the antistatic fiber include a metal fiber, a carbon fiber, a fiber in which metallic particles and carbon particles are mixed, and the like. The antistatic fiber preferably is added in a range of 0.1 to 1 mass % relative to the spun yarn, and more preferably in a range of 0.3 to 0.7 mass %. The antistatic fiber may be added at the time of weaving. For example, 0.1 to 1 mass % of “Beltron” manufactured by KB Seiren Ltd., a carbon fiber or a metal fiber may be added. In some cases, the antistatic fiber is not added to non-static products such as a curtain or a chair-covering sheet.

### EXAMPLES

The present invention will be described below in further detail by way of Examples. The measurement method used in the Examples and Comparative Examples of the present invention are as follows.

### (1) Flame Resistance

In accordance with EN 532-1995 specified in ISO 11613-1999 as the international performance standards, a flame was adjusted using a predetermined burner and was brought into contact horizontally with a laminate of fabrics oriented vertically, and the burner was positioned with its top end to be separated 17 mm from the fabrics.

### (2) Heat Resistance

Heat resistance at the time of heating at 180° C. for 5 minutes was measured in accordance with ISO 11613-1999, Annex A specified in ISO 11613-1999 as the international performance standards.

### (3) Washing Resistance

The fabric was washed five times in accordance with ISO 6330-1984, 2A-E specified in ISO 11613-1999 as the international performance standards.

### (4) Burn Resistance

In a case where the measurement result was no hole formation, no dripping and no melting and where the afterflame time and afterglow time were 0 seconds, the char length created by bringing a flame of a Bunsen burner into contact for 12 seconds with the lower end of a woven fabric sample oriented vertically, the afterflame time after the flame was removed, and the afterglow time were measured according to the method specified in JIS L1091A-4.

### (5) Electrification Voltage Test

The voltage immediately after electrification and the half life were measured according to the method for a frictional electrification attenuation measurement specified in JIS L1094 A-4.

### (6) Other Physical Properties

The other physical properties were measured in accordance with JIS or the industry standards.

### Example 1

### 1. Yarn-Dyeing

(1) Polyetherimide fiber

For a polyetherimide fiber, “Ultem” manufactured by Sabic Innovative Plastics (limiting oxygen index (LOI): 32; a single-fiber fineness; 3.3 decitex (3 deniers) and average fiber length: 89 mm) was used, and the fiber was dyed to olive-green color. A jet dyeing machine manufactured by Nissen Corporation was used as a dyeing machine, and dyes and other additives (Kayaron Polyester Yellow FSL (Nippon Kayaku Co., Ltd.) 3.60% o.w.f., Kayaron Red SSL (Nippon Kayaku Co., Ltd.) 0.36% o.w.f., Kayaron Polyester Blue SSL (Nippon Kayaku Co., Ltd.) 1.24% o.w.f., acetic acid (68 wt %) 0.0036% o.w.f., and sodium acetate 0.0067% o.w.f.) were added, and the dyeing treatment was carried out at 135° C. for 60 minutes.

### (2) Wool Fiber

For the wool fiber, an unmodified merino wool produced in Australia (average fiber length: 75 mm) was used, which was dyed to olive-green color with an ordinary method by using an acid dye.

### 2. Blending

Short fibers of 84.5 mass % of a polyetherimide fiber, 15.0 mass % of wool and 0.5 mass % of an antistatic fiber were blended. As the antistatic fiber, “Beltron” manufactured by KB Seiren Ltd., having a single-fiber fineness of 5.6 decitex (5 deniers) and an average fiber length of 89 mm was used.

### 3. Manufacture of Blended Yarn

The fibers were introduced separately into a card so as to open the fibers and to make a fibrous web, which then was blended using a sliver. The blended yarns were subjected to a fore-spinning step and a fine spinning step, thereby a spun yarn having a metric count of 80 (double yarn) (2/80), and a S twist of 68 times/10 cm and a Z twist of 85 times/10 cm was manufactured to be used as the warp. The weft was prepared from the same fibers in the same manner.

### 4. Fabrication of Woven Fabric

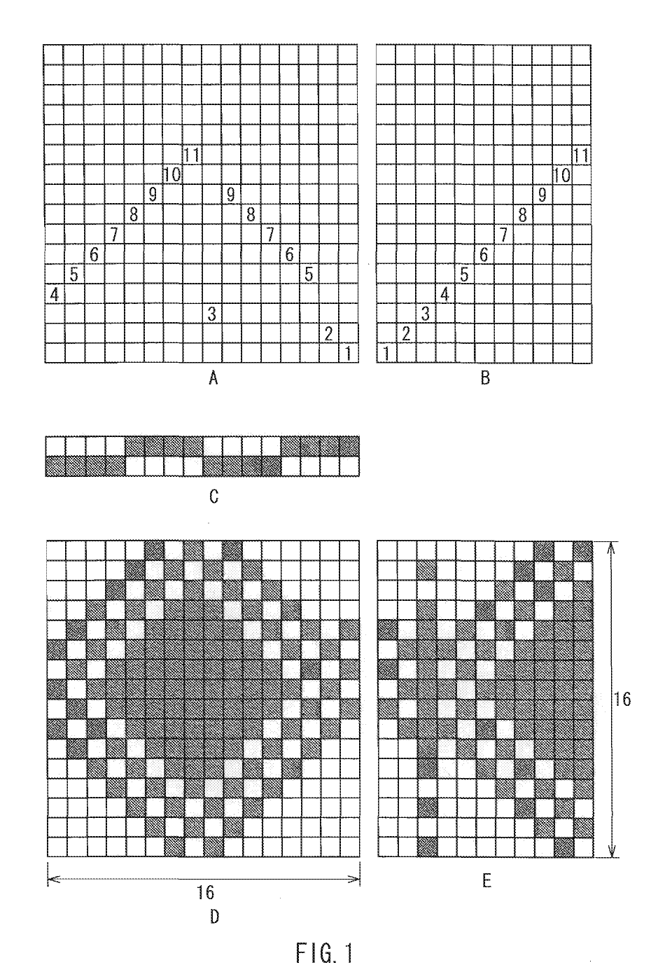

Using the spun yarns for the warp and the weft, a woven fabric having the honeycomb weave texture as shown in FIGS. 1A-1E was fabricated with a rapier loom. Each honeycomb was shaped as a rectangle about 5 mm in length and about 3 mm in width, and it forms a three-dimensional pattern about 1 mm in depth.

FIG. 1A shows an order of warping in heddles, which is counted from the cloth fell. Specifically, FIG. 1A indicates that the warps are passed in a sequential manner, i.e., the first warp from the left side is passed through the fourth heddle, and the second warp is passed through the fifth heddle, and the last and 16^{th} warp is passed through the first heddle.

FIG. 1B shows the order of heddles, and FIG. 1E shows floating (black square) and sinking (white square) for every heddle (FIG. 1B).

FIG. 1C shows draw-in of a reed, and specifically shows that four yarns are passed in every clearance between reeds.

FIG. 1D shows the texture of woven fabric, where each black square denotes a floating yarn, and each white square denotes a sinking yarn. The number ‘16’ at the bottom of FIG. 1D indicates that one stripe of 16 warps consists of one kind of yarn. FIG. 1E shows that one stripe of 16 wefts consists of one kind of yarn. Namely, it is shown that 16 warps/16 wefts compose a complete structure.

### 5. Evaluation

It was confirmed that according to ISO 11613-1999 as the international performance standards, this woven fabric exhibits the following properties. Namely, (1) flame resistance to be free from hole formation, dripping and melting; and to have afterflame time and afterglow time of not more than 2 seconds; (2) heat resistance to be free from firing, separation, dripping and melting; and to have a shrinkage rate of not more than 5%; and (3) washing resistance to have a shrinkage rate of not more than 3%. The physical properties and the testing methods are shown in Table 1.

TABLE 1

| Test item | | Physical property | | Testing method |
|---|---|---|---|---|
| Unit weight | Normal state | 217.8 | g/m² | JIS L 1096-8.4.2 |
| Pick density | Warp | 482 number/10 cm | | JIS L 1096-8.6.1 |
| | Weft | 334 number/10 cm | | |
| Tensile strength | Warp | 730 | N | JIS L 1096-8.12.1a (method A) |
| | Weft | 504 | N | |
| Tensile elongation | Warp | 53.4% | | JIS L 1096-8.12.1a (method A) |
| | Weft | 55.9% | | |
| Tear strength (A-2) | Warp | 39.1 | N | JIS L 1096-8.15.2 (method A-2) |
| | Weft | 36.9 | N | |
| Thickness | | 0.75 | mm | JIS L 1096-8.5.1 |
| Dimensional change (method C) | Warp | −0.5% | | JIS L 1096-8.64.4 (method C) |
| | Weft | 0.0% | | |
| Washing dimensional change | | | | ISO 11613-1999 |
| 5 times | Warp | −2.5% | | ISO 6330 2A-E |
| 5 times | Weft | −1.0% | | |
| 5 times | Appearance | grade 4 | | |
| Heat resistance Shrinkage rate | Warp | −3.0% | | ISO 11613-1999 Annex A |
| | Weft | −1.0% | | |
| Press shrinkage rate | | | | Method HESC103A |
| Immediately after | Warp | −0.2% | | |
| Immediately after | Weft | −1.7% | | |
| After balanced | Warp | −0.2% | | |
| After balanced | Weft | −1.4% | | |
| After humidification | Warp | 0.2% | | |
| After humidification | Weft | −1.7% | | |
| After immersion | Warp | 0.2% | | |
| After immersion | Weft | −1.5% | | |
| Frictional electrification attenuation | | | | JIS L 1094.5.4 |
| Immediately after | Warp | −650 | V | |
| Immediately after | Weft | 720 | V | |
| Half-life | Warp | 136.2 | sec. | |
| Half-life | Weft | 62.7 | sec. | |
| Flame resistance | | | | ISO 11613-1999→ in a case of |
| Char length | Warp | 13.4 | cm | afterflame•afterglow time of 0 |
| Char length | Weft | 11.3 | cm | second, JIS L 1091A-4 alternate |
| Afterflame | Warp | 1.0 | sec. | method (Annex 8), year of 1992 |
| Afterflame | Weft | 0.0 | sec. | flame contact: 12 seconds |
| Afterglow | Warp | 0.0 | sec. | (vertical method) |
| Afterglow | Weft | 0.9 | sec. | |

Next, the thus obtained woven fabric of honeycomb weave texture was sewn to fabricate an inner liner for fireproof clothing worn by a firefighter. The outermost layer of this fireproof clothing was provided in the following manner. Here, the core fiber was a para-aramid fiber (blend rate: 25.6 wt %), the cover fiber was composed of a meta-aramid fiber (blend rate: 74.0 wt %) and the antistatic fiber (blend rate: 0.4 wt %). For the core fiber, “Technora” manufactured by Teijin, Ltd., which is a stretch breaking yarn composed of a black spun-dyed product having a single-fiber fineness of 1.7 decitex (1.5 deniers), a fiber length of 37 to 195 mm (average fiber length: 106 mm), a metric count of 125 (single yarn), and a Z twist was used. The cover fiber used here was a bias-cut product of “Conex”, a meta-aramid fiber manufactured by Teijin, Ltd., having a single-fiber fineness of 2.2 decitex (2 deniers) and a fiber length of 76 to 102 mm (average fiber length: 89 mm). As the antistatic fiber, “Beltron” manufactured by KB Seiren Ltd., having a single-fiber fineness of 5.5 decitex (5 deniers) and an average fiber length of 89 mm was blended in the cover fiber. The blended fibers were spun with a ring spinning frame. The extent of overfeeding of the cover fiber bundle relative to the core fiber bundle was 7%. The direction of twist was the same as that of the stretch breaking yarn. The direction of twist and the twist number were the Z direction and 630 T/m (a twist number 1.4 times greater than the twist number of the stretch breaking yarn), respectively. The spun yarn thus obtained had a metric count of 32, and a breaking tenacity of 1019 N. The thus obtained multilayer-structured spun yarn was processed into a two-fold yarn, and in this instance a twist of 600 T/m was applied in the twist direction of S (yarn count/twist number: 2/32). Using this two-fold yarn, a plain-woven fabric having a warp density of 196 yarns/10 cm, a weft density of 164 yarns/10 cm, and a unit weight of 229.5 g/m² was obtained.

The physical properties of the woven fabric thus obtained were as follows.

(1) Char length according to the JIS L 1091 A-4 method (1992, flame contact: 12 seconds, vertical method), longitudinal: 2.0 cm, horizontal: 2.0 cm; afterflame time, longitudinal: 0.0 sec, horizontal: 0.0 sec; afterglow time, longitudinal: 0.9 sec, horizontal: 0.8 sec
(2) Voltage according to JIS L1094 5.4 (frictional electrification attenuation measurement method), immediately after, longitudinal: −260V, horizontal: −250V; half life, longitudinal: 20 sec, horizontal: 13.9 sec
(3) Tensile strength according to the JIS 1096A method (raveled strip method), longitudinal: 1980 N, horizontal: 1980 N; tensile elongation, longitudinal: 16.2%, horizontal: 8.4%
(4) Tear strength according to the JIS 1096A-2 method, longitudinal: 180.3 N, horizontal: 186.2 N
(5) Washing test

The dimensional change after a washing test according to ISO 6330 2A-E performed 5 times was −1.0% in a longitudinal direction and −1.5% in a horizontal direction, and the appearance was given grade 5 (no change in appearance).

Fireproof clothing applied with an inner liner in this manner shielded a radiant heat so that the comfort in wearing was kept preferable despite wetting from sweat during exertion under a high-temperature and severe environment, thereby exhibiting heat resistance for protecting human body.

### Example 2

A woven fabric was obtained similarly to Example 1 except for blending short fibers of 71.5 mass % of a polyetherimide fiber, 28.0 mass % of wool and 0.5 mass % of an antistatic fiber. In a measurement according to ISO 11613-1999 as the international performance standards, the obtained woven fabric had properties below:

(1) flame resistance to be free from hole formation, dripping and melting; and to have afterflame time and afterglow time of 0 second;
(2) heat resistance to be free from firing, separation, dripping and melting; and to have a shrinkage rate of 2.0%; and
(3) washing resistance to have a shrinkage rate of 2.0%. Namely, the quality was acceptable.

### Comparative Example 1

A woven fabric was obtained similarly to Example 1 except for blending short fibers of 49.5 mass % of a polyetherimide fiber, 50 mass % of wool and 0.5 mass % of an antistatic fiber. In a measurement according to ISO 11613-1999 as the international performance standards, the obtained woven fabric had properties below:

(1) flame resistance to be free from hole formation, dripping and melting; and to have afterflame time and afterglow time of 0 second;
(2) heat resistance to be free from firing, separation, dripping and melting; and to have a shrinkage rate of 1.5%; and
(3) washing resistance to have a shrinkage rate of 4.5%. Namely, the product was rejected.

### Example 3

A woven fabric was obtained similarly to Example 1 except for blending short fibers of 84.5 mass % of a polyetherimide fiber, 15.0 mass % of flame-retardant rayon: “Viscose FR” (trade name) manufactured by Lenzing AG (average fiber length: 75 mm, average fineness: 3.3 dtex), and 0.5 mass % of an antistatic fiber. In a measurement according to ISO 11613-1999 as the international performance standards, the obtained woven fabric had properties below:

(1) flame resistance to be free from hole formation, dripping and melting; and to have afterflame time and afterglow time of 0 second;
(2) heat resistance to be free from firing, separation, dripping and melting; and to have a shrinkage rate of 1.5%; and
(3) washing resistance to have a shrinkage rate of 2.0%. Namely, the quality was acceptable.

### Example 4

A woven fabric was obtained similarly to Example 1 except for blending short fibers of 84.5 mass % of a polyetherimide fiber, 15.0 mass % of flame-retardant acrylic fiber: “Kanekaron (modacrylic)” (trade name) manufactured by Kaneka Corporation (average fiber length: 100 mm, average fineness: 3.3 dtex), and 0.5 mass % of an antistatic fiber. In a measurement according to ISO 11613-1999 as the international performance standards, the obtained woven fabric had properties below:
(1) flame resistance to be free from hole formation, dripping and melting; and to have afterflame time and afterglow time of 0 second;
(2) heat resistance to be free from firing, separation, dripping and melting; and to have a shrinkage rate of 3.0%; and
(3) washing resistance to have a shrinkage rate of 1.0%. Namely, the quality was acceptable.

### Example 5

### 1. Fibers

A spun yarn was manufactured by using 100 mass % of a polyetherimide fiber. For the polyetherimide fiber, “Ultem” manufactured by Sabic Innovative Plastics (limiting oxygen index (LOI): 32); a single-fiber fineness: 3.3 decitex (3 deniers)) was used. For the average fiber length, fibers of 76 mm, 89 mm and 102 mm of the same contents were used.
2. Manufacture of Spun Yarn

The fibers were introduced separately into a card so as to open the fibers and to make a fibrous web, which then was blended using a sliver. The blended yarns were subjected to a fore-spinning step and a fine spinning, thereby a spun yarn having a metric count of 60 (double yarn) (2/60), and a S twist of 93 times/10 cm and a Z twist of 64 times/10 cm was manufactured to be used as the warp. The weft was prepared from the same fibers in the same manner.

### 3. Fabrication of Woven Fabric and Dyeing

Using the spun yarns for the warp and the weft, a woven fabric having a plain weave texture was fabricated with a rapier loom and then dyed to olive-green color. A jet dyeing machine manufactured by Nissen Corporation was used as a dyeing machine, and dyes and other additives (Kayaron Polyester Yellow FSL (Nippon Kayaku Co., Ltd.) 3.60% o.w.f., Kayaron Red SSL (Nippon Kayaku Co., Ltd.) 0.36% o.w.f., Kayaron Polyester Blue SSL (Nippon Kayaku Co., Ltd.) 1.24% o.w.f., acetic acid (68 wt %) 0.0036% o.w.f., and sodium acetate 0.0067% o.w.f.) were added, and the dyeing treatment was carried out at 135° C. for 60 minutes.

### 4. Evaluation

It was confirmed that according to ISO 11613-1999 as the international performance standards, this woven fabric exhibits the properties below: (1) flame resistance to be free from hole formation, dripping and melting; and to have afterflame time and afterglow of not more than 2 seconds; (2) heat resistance to be free from firing, separation, dripping and melting; and to have a shrinkage rate of not more than 5%; and (3) washing resistance to have a shrinkage rate of not more than 3%. The physical properties and the testing methods are shown in Table 2.

TABLE 2

| Test item | | Physical property | | Testing method |
|---|---|---|---|---|
| Unit weight | Normal state | 160.2 | g/m² | JIS L 1096-8.4.2 |
| Pick density | Warp | 236 number/10 cm | | JIS L 1096-8.6.1 |
| | Weft | 208 number/10 cm | | |
| Tensile strength | Warp | 548 | N | JIS L 1096-8.12.1a (method A) |
| | Weft | 423 | N | |
| Tensile elongation | Warp | 77.24% | | JIS L 1096-8.12.1a (method A) |
| | Weft | 60.1% | | |
| Tear strength (A-2) | Warp | 26.1 | N | JIS L 1096-8.15.2 (method A-2) |
| | Weft | 23.5 | N | |
| Dimensional change (method C) | Warp | 0.0% | | JIS L 1096-8.64.4 (method C) |
| | Weft | 0.0% | | |
| Washing dimensional change | | | | ISO 11613-1999 |
| 5 times | Warp | −0.5% | | ISO 6330 2A-E |
| 5 times | Weft | −0.5% | | |
| 5 times | Appearance | grade 4-5 | | |
| Heat resistance Shrinkage rate | Warp | −3.0% | | ISO 11613-1999 Annex A |
| | Weft | −3.0% | | |
| Press shrinkage rate | | | | Method HESC 103A |
| Immediately after | Warp | 0.0% | | |
| Immediately after | Weft | 0.3% | | |
| After balanced | Warp | 0.0% | | |
| After balanced | Weft | 0.1% | | |
| After humidification | Warp | 0.0% | | |
| After humidification | Weft | 0.3% | | |
| After immersion | Warp | 0.2% | | |
| After immersion | Weft | 0.3% | | |
| Frictional electrification attenuation | | | | JIS L 1094.5.4 |
| Immediately after | Warp | −9400 | V | |
| Immediately after | Weft | −10000 | V | |
| Flame resistance | | | | ISO 11613-1999→in a case of |
| Char length | Warp | 10.8 | cm | afterflame•afterglow time of 0 |
| Char length | Weft | 11.4 | cm | second, JIS L 1091A-4 alternate |
| Afterflame | Warp | 0.0 | sec. | method (Annex 8), year of 1992 |
| Afterflame | Weft | 0.0 | sec. | flame contact: 12 seconds |
| Afterglow | Warp | 0.6 | sec. | (vertical method) |
| Afterglow | Weft | 0.4 | sec. | |

### INDUSTRIAL APPLICABILITY

The fireproof fabric of the present invention can be applied not only to fire-fighting clothing but also widely to curtains, carpets, chair-covering sheets, panel materials, bed covering, wall papers used in hospitals, theaters, airplanes, vehicles and the like.

1. A fireproof fabric comprising a flame-retardant fiber,
the fabric is a woven fabric, a knitted fabric or a nonwoven fabric comprising 70 to 100 mass % of a polyetherimide fiber and 0 to 30 mass % of a flame-retardant fiber,
the fabric has flame resistance, heat resistance and wash resistance under ISO 11613-1999 as the international performance standards for fireproof clothing:
(1) flame resistance to be free from hole formation, dripping and melting; and to have afterflame time and afterglow time of not more than 2 seconds;
(2) heat resistance to be free from firing, separation, dripping and melting; and to have a shrinkage rate of not more than 5%; and
(3) washing resistance to have a shrinkage rate of not more than 3%.

2. The fireproof fabric according to claim 1, wherein
the flame-retardant fiber is at least one fiber selected from the group consisting of wool, flame-retardant rayon, flame-retardant acrylic, aramid, flame-retardant cotton and flame-retardant vinylon.

3. The fireproof fabric according to claim 1, further comprising an antistatic fiber.

4. The fireproof fabric according to claim 1, wherein the fabric comprises 75 to 95 mass % of the polyetherimide fiber and 5 to 25 mass % of the flame-retardant fiber.

5. The fireproof fabric according to claim 1, wherein the fabric is either a woven fabric or a knitted fabric of a spun yarn.

6. The fireproof fabric according to claim 1, wherein the polyetherimide single fiber has a fineness of not more than 3.9 decitex (3.5 deniers).

7. The fireproof fabric according to claim 1, wherein the polyetherimide fiber has an average fiber length in a range of 30 to 220 mm.

8. The fireproof fabric according to claim 1, wherein the polyetherimide fiber and the flame-retardant fiber are blended and spun to form a yarn of a woven fabric or a knitted fabric.

9. The fireproof fabric according to claim 1, wherein the polyetherimide fiber is dyed with a disperse dye.

10. Fireproof clothing comprising the fireproof fabric according to claim 1, wherein the fireproof fabric is used as an inner liner.
